(19) United States
(12) Patent Application Publication
(10) Pub. No.: US 2008/0126294 A1
(43) Pub. Date: May 29, 2008

(54) METHODS AND APPARATUS FOR COMMUNICATING MEDIA FILES AMONGST WIRELESS COMMUNICATION DEVICES

(75) Inventors: Rajarshi Ray, San Diego, CA (US); Premkumar Jothipragasam, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 11/554,534

(22) Filed: Oct. 30, 2006

(51) Int. Cl. G06F 17/30

(52) U.S. Cl. 707/1

(57) ABSTRACT

Methods and apparatus are provided for communicating of media files between wireless communication devices. A media file is segmented and speech-encoded on a first wireless communication device and subsequently communicated, typically via Multimedia Peer (M2-Peer) communication, to a second communication device, which decodes and concatenates the speech-encoded media file for subsequent playback capability on the second communication device.

### REFERENCE TO CO-PENDING APPLICATION FOR PATENT

The present application for patent is related to the following co-pending U.S. patent applications: “Methods and Apparatus for Recording Broadcast Media on a Wireless Communication Device” by Rajarshi Ray et al., having Attorney Docket No. 060947, filed concurrently herewith, assigned to the assignee hereof, and expressly incorporated by reference herein.

### BACKGROUND

The disclosed aspects relate to wireless communication devices, and more particularly, to systems and methods for communicating media files amongst wireless communication devices.

Wireless communication devices, such as cellular telephones, have rapidly gained in popularity over the past decade. These devices are rapidly becoming multifaceted devices capable of providing a wide-range of functions. For example, a cellular telephone may also embody computing capabilities, Internet access, electronic mail, text messaging, GPS mapping, digital photographic capability, an audio/MP3 player, video gaming capabilities, video broadcast reception capabilities and the like.

The cellular telephone that also incorporates an audio/MP3 player and/or a video player and/or a video game player is becoming increasingly popular, especially amongst a younger age demographic of device users. Such a device provides an advantage over the stand-alone audio/MP3 player device, video player device or video gaming device, in that, cellular communication provides an avenue to download songs, videos or video games directly to the wireless communication device without having to first download the songs, videos or games to a personal computer, laptop computer or other device with an Internet connection. This ability to instantaneously obtain media files (e.g., songs, CDs, videos, movies, games, graphics or the like) is very attractive to the users who regularly demand the media at the spur of the moment.

In addition to obtaining media on-demand and in a mobile environment, many users enjoy being able to instantaneously share media files with friends, colleagues and the like. Wireless handset-to-wireless handset sharing of media files provides many problems. One the problems related to sharing media files is that the files are typically protected by copyright laws, which forbid the sharing of media files without acquiring requisite licenses (e.g., paying a licensing fee). However, many media content providers are allowing users to share media files if the media file is somewhat limited, degraded or altered, such that the shared media file does not provide the same user experience as the original unaltered file. The concept benefits from the user of the shared media file hopefully being enticed into purchasing an unaltered “clean” copy of the file. Altering or limiting the media file may include limiting the amount of “plays,” providing a shared copy of degraded quality or providing only a portion of the file, commonly referred to as a snippet, that is made available by content providers for promotional purposes.

Another problem with wireless handset-to-wireless handset sharing of media files is that the files tend to be large in size and therefore sharing the file over the cellular network is not readily feasible. For example, a compressed 4-minute MP3 audio file is approximately 3.5 MB (mega bytes) in size. Even more advanced compression techniques, such as implemented in Advanced Audio Coding Plus (AAC+), result in corresponding audio files that are approximately 700 KB (kilobytes) in size. Further, song files are relatively small in size compared to video files and video game files. Thus, such large file sizes make any of the current cellular network data transfer methods either impractical or incapable of reliably transferring the file from one wireless handset to another.

Therefore a need exists to develop methods and apparatus for sharing media files amongst wireless handsets.

### SUMMARY

The disclosed apparatus and methods provide for the communication of media files amongst wireless communication devices. In some aspects, the apparatus and method may be able to provide for media file sharing instantaneously in a mobile environment and, as such, obviate the need to first communicate the files to a PC or other computing device before sharing the media file with another wireless device. In other aspects, the apparatus and method may overcome media file size limitations, such that sharing of the files over the existing wireless network is feasible from a reliability standpoint and a delivery time standpoint. In addition, in yet other aspects, the method and apparatus may take into account intellectual property rights associated with media files, such that the sharing of the media files provides the holder of the intellectual property rights with an avenue for enticing a licensed purchase by the party to whom the media file is shared.

In particular, devices, methods, apparatus, computer-readable media and processors are presented that provide for media files, such as music files, audio files, video files, and the like, to be segmented and speech-encoded on a first wireless communication device (e.g., the communicating device) and subsequently communicated to a second communication device (e.g., the receiving device), which decodes the speech-encoded media file and concatenates the segments for subsequent playing capability on the second communication device. Since peer-to-peer communication, such as multimedia peer (M2-Peer) communication or the like, is limited in terms of the length of the file that can be communicated, in many aspects, the media file will require segmentation at the first communication device prior to communicating the media file to the second communication device, which, in turn, will require concatenation of the segments prior to playing the media file.

Thus, the described aspects provide for instantaneous media file sharing in a mobile environment. The described aspects obviate the need to first communicate the files to a PC, other computing device or secondary wireless communication device before sharing the media file with another wireless device. In addition, the described aspects take into account the large size of a media file and insure that the communication of such files amongst wireless communication devices is accomplished in an efficient and reliable manner. Also, by transferring media files in a degraded lower quality speech format as opposed to a higher quality audio format the aspects herein described are generally viewed as acceptable means of transferring media files without infringing on copyright protection.

In one specific aspect, a method for preparing a media file for wireless device-to-wireless device communication includes receiving a media file at a first wireless communication device, segmenting an audio signal of the media file into two or more audio segments, and encoding the audio signal of the media file in speech format. In some aspects, the segmenting of the audio signal may occur prior to encoding the audio signal in a speech format; while in other aspects the segmenting may occur after encoding the audio signal in a speech format. In those aspects, in which the media file includes audio and video portions, the method may also include segregating an audio signal and a video signal of the media file and segmenting the video signal into two or more video segments. The method may also include communicating, individually, the audio and video segments of the speech-formatted media file using Multimedia Peer (M2-Peer) communication network.

Additionally, an aspect is defined by at least one processor that is configured to perform the actions of receiving a media file at a first wireless communication device, segmenting an audio signal of the media file into two or more audio segments, and encoding the audio signal of the media file in speech format.

A related aspect is defined by a machine-readable medium including instructions stored thereon. The instructions include a first set of instructions for receiving a media file at a first wireless communication device, a second set of instructions for segmenting an audio signal of the media file into two or more audio segments, and a third set of instructions for encoding the audio signal of the media file in speech format.

A further aspect is defined by a wireless communication device that includes a computer platform including a processor and a memory. The device also includes a media player module and a media file segmentor stored in the memory and executable by the processor. The media player module is operable for receiving a media file and the media file segmentor is operable for segmenting an audio signal of the media file into two or more audio segments. The device also includes a Multi-Media Peer (M2-Peer) communication module stored in the memory and executable by the processor. The M2-Peer module includes a speech vocoder operable for encoding the audio signal of the media file into a speech format and a communications mechanism operable for communicating the two or more speech-formatted audio segments to a second wireless communication device. The media player module may also include an audio file codec operable for audio decoding a compressed media file. In alternate aspects, the media file segmentor may be included in the media player module or in the M2-Peer communication module. In other aspects the device may include an audio/video segregator that is operable for segregating the media file into an audio signal and a video signal. In such aspects, the media file segmentor may be further operable for segmenting the video signal into two or more video segments and the communication mechanism of the M2-Peer communication module may be further operable for communicating the two or more video segments to a second wireless communication device.

A related aspect is defined by a wireless communications device. The device includes a means for receiving a media file at a first wireless communication device a means for segmenting an audio signal of the media file into two or more, and a means for segments; encoding the audio signal of the media file in speech format.

Additionally, an aspect is defined by a method for receiving a shared media file on a wireless communication device. The method includes receiving two or more Multimedia Peer (M2-Peer) communications at a wireless communication device, identifying the two or more M2-Peer communications as including an audio segment of a media file, decoding the audio segments resulting in speech-grade audio segments of the media file and concatenating the audio segments of the media file to form an audio portion of the media file. Decoding the M2-Peer message may entail decoding the speech-encoded format to audio digital signals or decoding the speech-encoded format to compressed audio format and decoding the compressed audio format to audio digital signals. In alternate aspects, the method may include identifying the two or more M2-Peer communications as including at least one of a video segment and an audio segment of the media file, concatenating the video segments to form a video portion of the media file and/or aggregating the audio portion and video portion to form the media file.

A related aspect is defined by at least one processor configured to perform the actions of receiving two or more Multimedia Peer (M2-Peer) communications at a wireless communication device, identifying the two or more M2-Peer communications as including an audio segment of a media file, decoding the audio segments resulting in speech-grade audio segments of the media file and concatenating the audio segments of the media file to form an audio portion of the media file.

A further related aspect is defined by a machine-readable medium including instructions stored thereon. The instructions include a first set of instructions for receiving two or more Multimedia Peer (M2-Peer) communications at a wireless communication device, a second set of instructions for identifying the two or more M2-Peer communications as including an audio segment of a media file, a third set of instructions for decoding the audio segments resulting in speech-grade audio segments of the media file and a fourth set of instructions for concatenating the audio segments of the media file to form an audio portion of the media file.

Another aspect is provided for by a wireless communication device that receives media file M2-Peer communications. The device includes a computer platform including a processor and a memory and a Multi-Media Peer (M2-Peer) communication module stored in the memory and executable by the processor. The M2-Peer communication module is operable for receiving two or more M2-Peer communications and identifying the communications as including an audio segment of a media file. The device also includes a speech vocoder operable for decoding the audio segments resulting in speech-grade audio segments of the media file and a concatenator operable for concatenating the audio segments of the media file to form an audio portion of a media file. The device may also include a media player application that is operable for receiving and playing the speech-grade audio segments of the media file. The M2-Peer communication module may further include an audio file codec operable for decoding a compressed media file. In alternate aspects, the M2-Peer communication module may be further operable for identifying the two or more M2-Peer communications as including at least one of a video segment and an audio segment of the media file. In such aspects, the concatenator may be further operable to concatenate the video segments to form a video portion of the media file and the device may further include an aggregator operable for aggregating the audio portion and the video portion to form the media file.

In a related aspect, a wireless communication device for receiving M2-Peer messages including media file includes a means for receiving two or more Multimedia Peer (M2-Peer) communications at a wireless communication device, a means for identifying the two or more M2-Peer communications as including an audio segment of a media file, a means for decoding the audio segments resulting in speech-grade audio segments of the media file and a means for concatenating the audio segments of the media file to form an audio portion of the media file.

Thus, the aspects described herein provided for methods, apparatus and systems for communicating media files between wireless communication devices using Multi-Media Peer (M2-Peer) communication. The mobile nature of the communication process allows for media files to be shared from wireless device-to-wireless device without implementing a PC or other computing device. Additionally, by implementing a method that allows for segmenting of large media files on the communicating device prior to M2-Peer communication and the subsequent concatenation of the segments on the receiving device, communication of media files can occur efficiently and reliably. The present aspects also provide for converting the media files to a speech grade file, such that playback of the media file on the receiving device is at a degraded level that is acceptable to media content providers from a copyright standpoint.

### BRIEF DESCRIPTION OF THE DRAWINGS

The disclosed aspects will hereinafter be described in conjunction with the appended drawings, provided to illustrate and not to limit the disclosed aspects, wherein like designations denote the elements, and in which:

FIG. 1 is a block diagram of a system for communicating media files amongst wireless communication devices using a multimedia peer communication network, in accordance with an aspect;

FIG. 2 is block diagram of a wireless device for communicating media files using a multimedia peer (M2-Peer) communication network, in accordance with an aspect;

FIG. 3 is a block diagram of a wireless device for receiving media files communicated through a M2-Peer communication network, in accordance with another aspect;

FIG. 4 is a schematic diagram of one aspect of a cellular telephone network implemented in the present aspects for communicating media files to the wireless devices prior communicating the media files between the wireless devices;

FIG. 5 is a block diagram representation of wireless communication between the wireless communication devices and network devices, such as media content servers, in accordance with an aspect;

FIG. 6 is a flow diagram of a method for communicating and receiving an audio media file using a M2-Peer communication network, in accordance with an aspect;

FIG. 7 is a flow diagram of a method for communicating and receiving an audio and video media file using a M2-Peer communication network, in accordance with an aspect;

FIG. 8 is a flow diagram of an alternate method for communicating and receiving an audio media file using a M2-Peer communication network, in accordance with an aspect;

FIG. 9 is a flow diagram of a method for preparing a media file for peer-to-peer communication, according to another aspect; and

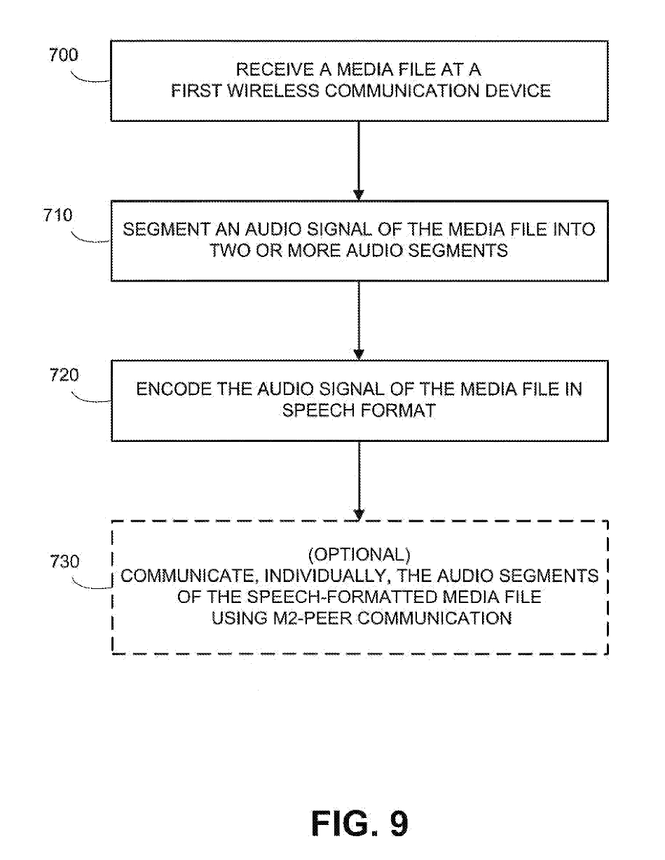

FIG. 10 is a flow diagram of a method for receiving and accessing a segmented and speech-formatted media file, in accordance with an aspect.

### DETAILED DESCRIPTION

The present devices, apparatus, methods, computer-readable media and processors now will be described more fully hereinafter with reference to the accompanying drawings, in which aspects of the invention are shown. The devices, apparatus, methods, computer-readable media and processors, however, may be embodied in many different forms and should not be construed as limited to the aspects set forth herein; rather, these aspects are provided so that this disclosure will be thorough and complete, and will fully convey the scope of the invention to those skilled in the art. Like numbers refer to like elements throughout.

The various aspects are described herein in connection with a wireless communication device. A wireless communication device can also be called a subscriber station, a subscriber unit, mobile station, mobile, remote station, access point, remote terminal, access terminal, user terminal, user agent, a user device, or user equipment. A subscriber station may be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem.

The described aspects provide for methods, apparatus and systems for communicating media files between wireless communication devices using Multi-Media Peer (M2-Peer) communication. See, for example, U.S. patent application Ser. No. 11/202,805, entitled “Methods and Apparatus for Providing Peer-to-Peer Data Networking for Wireless Devices,” filed on Aug. 12, 2005, in the name of inventors Duggal et al, and assigned to the same inventive entity as the present aspect. The '805 Duggal application describes methods and apparatus for providing server-less peer-to-peer communication amongst wireless communication devices. The '805 Duggal application is hereby incorporated by reference as if set forth fully herein.

The mobile nature of the communication process allows for media files to be shared from wireless device-to-wireless device, instantaneously, without implementing a PC or other computing device. Additionally, by implementing a method that allows for segmenting of large media files on the communicating device prior to M2-Peer communication and the subsequent concatenation of the segments on the receiving device, communication of media files can occur efficiently and reliably. The present aspects also provide for converting the media files to a speech grade file, such that playback of the media file on the receiving device is at a degraded level that is acceptable to media content providers from a copyright standpoint.

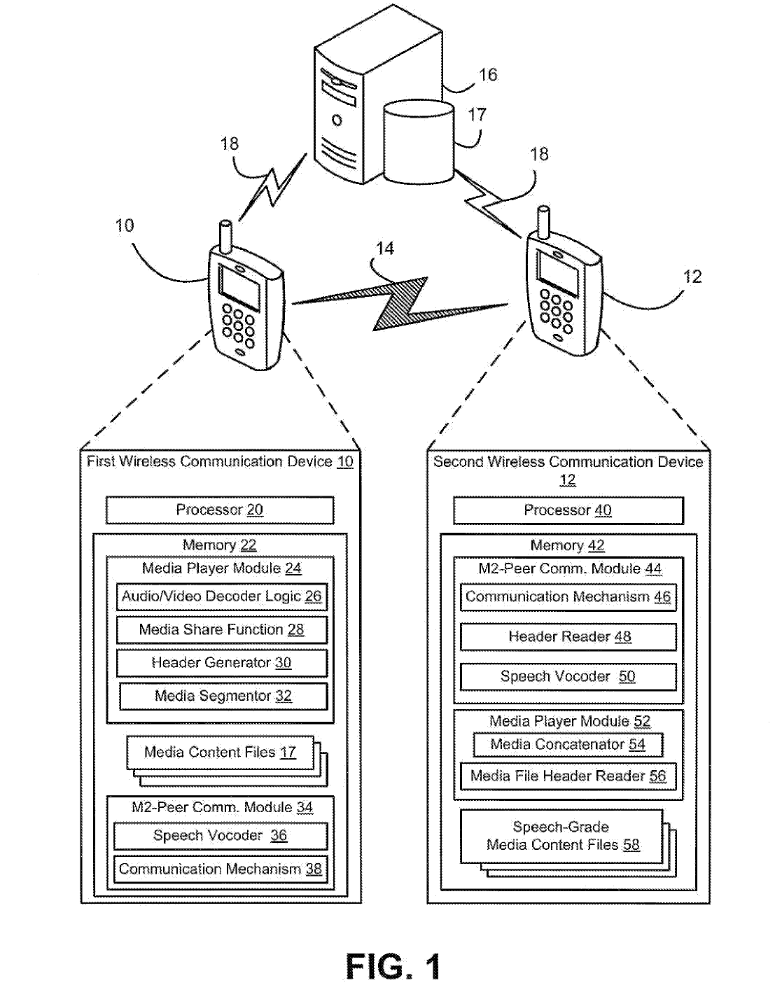

Referring to FIG. 1, a schematic representation of a system for M2-Peer communication of media files among wireless communication devices is depicted. The system includes a first wireless communication devices 10, also referred to herein as the communicating device, and a second wireless communication device 12, also referred to herein as the receiving device. The first and second wireless communication devices are in wireless communication via M2-Peer communication network 14. It should be noted that while the first wireless communication device 10 is described as the media file communicating device and the second wireless communication device is described as the media file receiving device, in most instances the wireless communication devices will be configured to be capable of both communicating and receiving media files via the M2-Peer communication network. It is only for the sake of clarity that the wireless communication devices are described herein as being media file communicating device or a media file receiving device. Thus, the wireless devices described and claimed herein should not be viewed as limited to a device that communicates media files or a device that receives media files but should include wireless communication devices that are capable of both communicating and receiving media files.

The M2-Peer communication network 14 is a network that relies primarily on the computing power and bandwidth of the participants in the network (e.g., first and second wireless communication devices 10, 12) rather that concentrating power and bandwidth in a relatively in network servers. A M2-Peer network does not have the notion of clients or servers, but only equal peer nodes that simultaneously function as both “clients” and “servers” to the other nodes on the network. This model of network arrangement differs from the client-server model where communication is usually to and from a central server. In a M2-Peer communication network there is no central server acting as a router to manage the network.

The first and second wireless communication devices 10 and 12 may additionally support wireless network communication through a conventional wireless network 18, such as a cellular telephone network. Wireless network 18 may provide for the wireless communication devices 10 and 12 to receive media content files, such as audio/music files, video files and/or multimedia files from a media content service provider. In the illustrated embodiment the media content service provider is represented by media content server 16 that has access to a plurality of media content files 17. Wireless communication devices 10 and 12 may request or otherwise receive a media content file from media content server 16 sent via wireless network 18. Alternatively, the wireless communication devices 10 and 12 may receive media content files from other sources, such as, transferred via a USB connection to another device, wireless or wired, that stores the media file or transferred via removable flash memory storage capability.

The first wireless communication device 10 also referred to herein as the media file communicating device, includes at least one processor 20 and a memory 22. The memory 22 includes a media player module 24 that is operable for receiving media content files 17 from a media content service provider or from another source as described above. In addition, media player module 24 is operable to store and subsequently consume, e.g. “play” or execute the media content files at the wireless communication device. In the described aspect, the media player module 24 may include audio/video decoder logic 26 that is operable for decoding the received audio signal and, when applicable, video signal of the media file 17 prior to storage. For example, in the instance in which the media file is an audio file, the received audio signal may be received as a MPEG (Motion Pictures Expert Group) Audio Layer III formatted file, commonly referred to as MP3, or an Advanced Audio Code (AAC) formatted file or any other compressed audio format that requires decoding prior to consumption. The decoded file, typically a pulse code modulation (PCM) file is subsequently consumed/played or stored in memory 22 for later consumption/play.

The media player module 24 may additionally include a media share function 28 that is operable to provide a media file share option to the user of the first wireless communication device 10. The share option allows the user to designate a media file for sharing with another wireless communication device via M2-Peer communication. In one example, the media player module 24 may be configured with a displayable menu item that allows the user to choose the media file share option or, alternatively, upon receipt or playing of a media file the media player module may be configured to provide for a pop-up window that queries the user as to their desire to share the media file or and other media file share mechanism may be presented to the device user. In addition to providing the user a media file share option, the media share function may additionally provide for the user to choose or enter the address of the one or more recipients of the media file.

The media player module 24 may additionally include a header generator 30 and a media segmentor 32. Once a user has designated a media file for sharing, header generator 30 is operable for generating a header that will be attached to all of the M2-Peer communications that include a segment of the media file. The header portion of the communication serves to identify the M2-Peer communication as including a media file. Such identification allows for the receiving device 12 to recognize the M2-Peer communication as a media file communication and perform the necessary post processing and forwarding of the file to the receiving device's media player module. In addition, the header information may include other information relevant to the media file. For example, advertising information, such as a link to a media file service provider, may be included in the header information. The advertising information may be displayed or otherwise presented on the receiving wireless communication device, allowing the user of the receiving wireless communication device access to purchasing or otherwise receiving a commercial grade audio formatted copy of the media file.

The media segmentor 32 of media player module 24 is operable for segmenting the audio portion and, where applicable, the video portion of the of the media file into audio and video segments (e.g., mini-clips). Segmentation of the media files is typically required because M2-Peer communications are generally limited in terms of allowable length. If a file size exceeds a certain predetermined length, for example 60 seconds to 90 seconds maximum, the M2-Peer communication network may not be able to reliably communicate the file to the designated recipient device. By parsing the media content file into segments, present aspects provide for each individual audio or video segment to be communicated via the M2-Peer network and for the receiving device to concatenate the audio segments, and where applicable video segments, resulting in the composite media content file.

The memory 22 of first wireless communication device 10 also includes an M2-Peer communication module 34 that is operable for communicating the media file segments to the designated share recipients via the M2-Peer communication network. The M2-Peer communication module 34 also includes a speech vocoder 36 operable for encoding the audio portion of the media file into a speech-grade audio format. The speech-grade audio format will characteristically have a limited bandwidth in the range of about 20 hertz (Hz) to about 20 kilohertz (kHz). By comparison, conventional multimedia content files may have audio formatted in the bandwidth range of about 5 Hz to about 50 Hz. Examples of speech-grade audio formats include, but are not limited to, Qualcomm Code Excited Linear Predictive (QCELP), Enhanced Variable Rate Codec (EVCR), Internet Low Bitrate Codec (iLBC), Speex and the like. Encoding the audio portion of the media file in speech-grade format ensures that the shared file exists on the recipient's device in a degraded audio state. The speech-grade format of the media file allows for the recipient to “play” or otherwise consume the media content file in a lower quality form than that which would be afforded by the higher audio quality copy available from the media content service provider. In other aspects, the media file may be further protected by including a watermark in the shared speech-grade media file or limiting the number of allowable “plays” on the receiving device.

The M2-Peer communication module 34 also includes a communication mechanism 38 operable for communicating the speech-formatted segments of the media file to the one or more designated share recipients. As previously noted, the communication 38 will typically also be operable for receiving speech-formatted segments of media files being shared by other wireless communication devices. As such, the M2-Peer communication module 34 included in the first wireless communication device 10 may include any and all of the components, logic and functionality exhibited by the M2-Peer communication module 44 discussed in relation to the second wireless communication device 12.

The second wireless communication device 12, also referred to herein as the media file receiving or recipient device, includes at least one processor 40 and a memory 42. The memory 42 includes an M2-Peer communication module 44. The M2-Peer communication module includes a communication mechanism 46 operable for receiving and communicating M2-Peer communications, including speech-formatted segments of media files. As such, the M2-Peer communication module 44 included in the second wireless communication device 12 may include any and all of the components, logic and functionality exhibited by the M2-Peer communication module 34 discussed in relation to the first wireless communication device 10.

The M2-Peer communication module 44 additionally may include a header reader 48 operable for reading and interpreting the information included in the M2-Peer communication headers. The header information will typically identify an M2-Peer communication as including a segment of a media file and the associated speech format used to encode the segment. By identifying the communication as including a segment of a media file, the M2-Peer communication module recognizes that the file needs to be communicated to the media player module 52 for subsequent concatenation of the segments and/or media file consumption/playing. The header reader 48 may also be operable for identifying other information related to the media file, such as advertising information that may be displayed or otherwise presented in conjunction with the consumption/playing of the media file.

The M2-Peer communication module 44 may include speech vocoder 50 operable for decoding the speech-formatted audio segments of the media file. The speech vocoder 50 may be configured to provide decoding of one or more speech-format codes and, at a minimum, decoding of the speech format used by the communicating/sharing wireless communication device 10. The decoding of the audio segments results in speech-grade, pulse code modulation segments (e.g., mini-clips) that are forwarded to the media player module 52.

The memory 42 of second wireless communication device 12 may additionally include a media player module 52 operable for receiving and consuming/playing speech-grade media files. The media player module 52 may include media concatenator 54 operable for assembling the segments of the media file in sequence to create the speech-grade media content files 58. The media player module 52 may additionally include a header reader 56 that is operable for identifying a sequence identifier included within the header that is used by the concatenator 54 in assembling the media file in proper sequence. The header reader 56 may additionally be operable for identifying additional information related to the media file, such as advertising information, in the form of media file service provider links or the like, that may be displayed or otherwise presented to the user during the consumption/playing of the speech-grade media file 58 at the second wireless communication device 12.

As previously noted, the speech-grade media files 58 provide for a lesser-audio quality grade file than the commercial grade media file. The speech-grade media files 58 may be further protected from illegal use by inclusion of a watermark inserted at the communicating/sharing device or at the receiving device or by limiting the number of plays that the file may be consumed/played at the second wireless communication device 12.

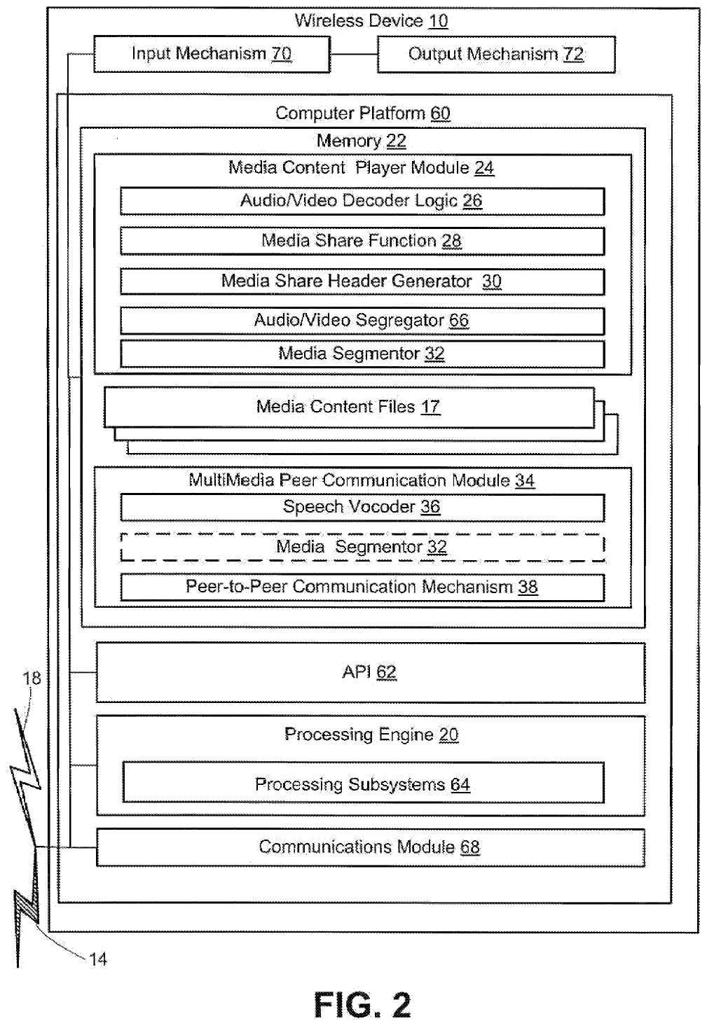

Referring to FIG. 2, according to one aspect, a block diagram representation of a first wireless communication device 10, otherwise referred to as the communicating or sharing wireless device, operable for sharing speech-grade media files via M2-Peer communication is depicted. The wireless communication device 10 may include any type of computerized, communication device, such as cellular telephone, Personal Digital Assistant (PDA), two-way text pager, portable computer, and even a separate computer platform that has a wireless communications portal, and which also may have a wired connection to a network or the Internet. The wireless communication device can be a remote-slave, or other device that does not have an end-user thereof but simply communicates data across the wireless network, such as remote sensors, diagnostic tools, data relays, and the like. The present apparatus and methods can accordingly be performed on any form of wireless communication device or wireless computer module, including a wireless communication portal, including without limitation, wireless modems, PCMCIA cards, access terminals, desktop computers or any combination or sub-combination thereof.

The wireless communication device 10 includes computer platform 60 that can transmit data across a wireless network, and that can receive and execute routines and applications. Computer platform 60 includes memory 22, which may comprise volatile and nonvolatile memory such as read-only and/or random-access memory (RAM and ROM), EPROM, EEPROM, flash cards, or any memory common to computer platforms. Further, memory 22 may include one or more flash memory cells, or may be any secondary or tertiary storage device, such as magnetic media, optical media, tape, or soft or hard disk.

Further, computer platform 60 also includes a processing engine 20, which may be an application-specific integrated circuit (“ASIC”), or other chipset, processor, logic circuit, or other data processing device. Processing engine 20 or other processor such as ASIC may execute an application programming interface (“API”) layer 62 that interfaces with any resident programs, such as media player module 24 and/or M2-peer communication module 34, stored in the memory 22 of the wireless device 10. API 62 is typically a runtime environment executing on the respective wireless device. One such runtime environment is Binary Runtime Environment for Wireless® (BREW®) software developed by Qualcomm, Inc., of San Diego, Calif. Other runtime environments may be utilized that, for example, operate to control the execution of applications on wireless computing devices.

Processing engine 20 includes various processing subsystems 64 embodied in hardware, firmware, software, and combinations thereof, that enable the functionality of communication device 10 and the operability of the communication device on a wireless network. For example, processing subsystems 64 allow for initiating and maintaining communications, and exchanging data, with other networked devices. In aspects in which the communication device is defined as a cellular telephone the communications processing engine 24 may additionally include one or a combination of processing subsystems 64, such as: sound, non-volatile memory, file system, transmit, receive, searcher, layer 1, layer 2, layer 3, main control, remote procedure, handset, power management, digital signal processor, messaging, call manager, Bluetooth® system, Bluetooth® LPOS, position engine, user interface, sleep, data services, security, authentication, USIM/SIM, voice services, graphics, USB, multimedia such as MPEG, GPRS, etc (all of which are not individually depicted in FIG. 2 for the sake of clarity). For the disclosed aspects, processing subsystems 64 of processing engine 24 may include any subsystem components that interact with the media player module 24 and/or the M2-Peer communication module 34 on computer platform 60.

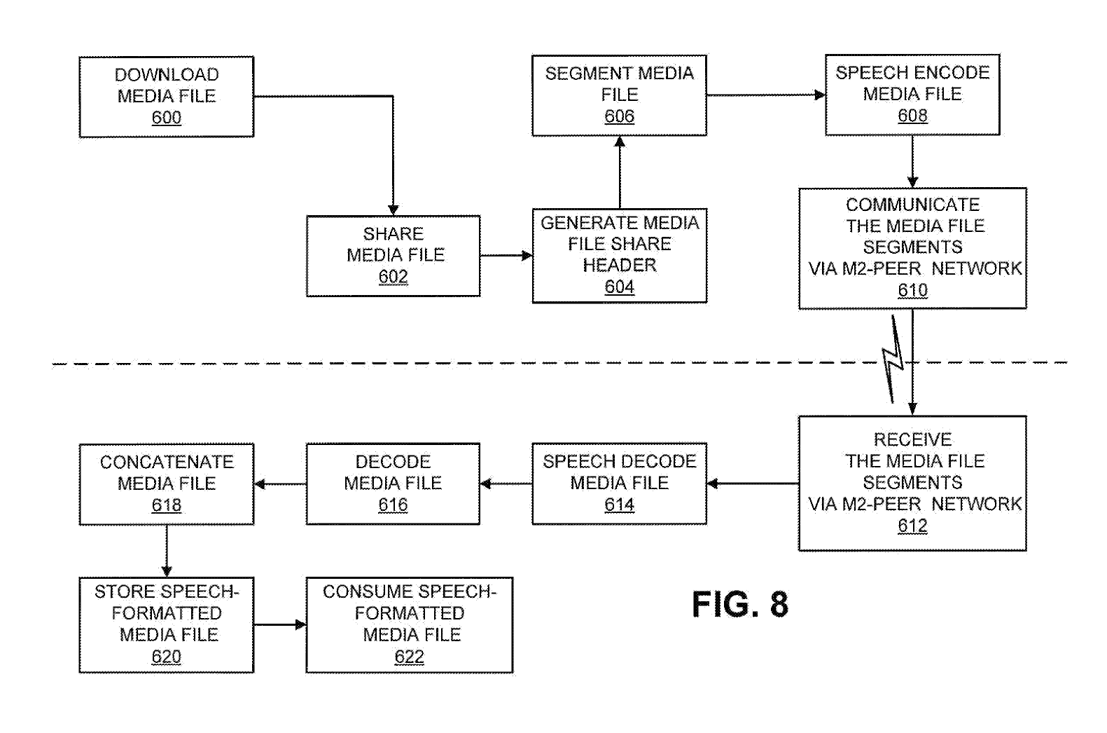

The memory 22 of computer platform 60 includes a media player module 24 that is operable for receiving media content files 17 from a media content service provider or from another source as described above. In addition, media player module 24 is operable to store and subsequently consume, e.g. “play” or execute the media content files at the wireless communication device. In the described aspect, the media player module 24 may include audio/video decoder logic 26 that is operable for decoding the received audio signal and, when applicable, video signal of the media file 17 prior to storage. For example, in the instance in which the media file comprises an audio file, the received audio signal may be received as a MPEG (Motion Pictures Expert Group) Audio Layer III formatted file, commonly referred to as MP3, or an Advanced Audio Code (AAC) formatted file or any other compressed audio format that requires decoding prior to consumption. The decoded file, typically a pulse code modulation (PCM) file is subsequently consumed/played or stored in memory 22 for later consumption/play. In alternate aspects, the decoding of the received compressed media content file may occur at the receiving wireless communication device 12, obviating the need to perform audio/video decoding at the first wireless communication device 10. FIG. 8 provides a flow diagram of a method that provides for compressed audio decoding at the second wireless communication device and will be discussed in detail infra.

The media player module 24 may additionally include a media share function 28 that is operable to provide a media file share option to the user of the first wireless communication device 10. The share option allows the user to designate a media file for sharing with another wireless communication device via M2-Peer communication. In one example, the media player module 24 may be configured with a displayable menu item that allows the user to choose the media file share option or, alternatively, upon receipt or playing of a media file the media player module may be configured to provide for a pop-up window that queries the user as to their desire to share the media file or and other media file share mechanism may be presented to the device user. In addition to providing the user a media file share option, the media share function may additionally provide for the user to choose or enter the address of the one or more recipients of the media file.

The media player module 24 may additionally include a header generator 30. Once a user has designated a media file for sharing, header generator 30 is operable for generating a header that will be attached to all of the M2-Peer communications that include a segment of the media file. The header portion of the communication serves to identify the M2-Peer communication as including a media file. Such identification allows for the receiving device 12 to recognize the M2-Peer communication as a media file communication and perform the necessary post processing and forwarding of the file to the receiving device's media player module. In addition, the header information may include other information relevant to the media file. For example, advertising information, such as a link to a media file service provider, may be included in the header information. The advertising information may be displayed or otherwise presented on the receiving wireless communication device, allowing the user of the receiving wireless communication device access to purchasing or otherwise receiving a commercial grade audio formatted copy of the media file.

The media player module 24 may additionally include an audio/video segregator 66 that is implemented when the media file to be shared includes both audio and video portions. The audio/video segregator is operable for segregating out the video portion and audio portion of the media file for processing purposes. Subsequent to the segregation of the audio and video portions, the audio portion will be segmented and speech-encoded prior to M2-Peer communication and the video portion will be segmented prior to M2-Peer communication. At the receiving wireless communication device 12, the video portion and the audio portion are aggregated to form the composite media file.

The media player module 24 also may include a media segmentor 32 that is operable for segmenting the audio portion and, where applicable, the video portion of the of the media file into audio and video segments (e.g., mini-clips). Segmentation of the media files is typically required because M2-Peer communications are generally limited in terms of allowable length. If a file size exceeds a certain predetermined length, for example 60 seconds to 90 seconds maximum length, the M2-Peer communication network may not be able to reliably communicate the file to the designated recipient device. By parsing the media content file into segments, present aspects provide for each individual audio and, where applicable, video segment to be communicated via the M2-Peer network and for the receiving device to concatenate the audio segments, and where applicable video segments, resulting in the composite media content file.

The memory 22 of first wireless communication device 10 also includes an M2-Peer communication module 34 that is operable for communicating the media file segments to the designated share recipients via the M2-Peer communication network. The M2-Peer communication module 34 also includes a speech vocoder 36 operable for encoding the audio portion of the media file into a speech-grade audio format. As previously noted, the speech-grade audio format will characteristically have a limited bandwidth in the range of about 20 Hz to about 20 Khz. Encoding the audio portion of the media file in speech-grade format ensures that the shared file exists on the recipient's device in a degraded audio state. The speech-grade format of the media file allows for the recipient to “play” or otherwise consume the media content file in a lower quality form than that which would be afforded by the higher audio quality copy available from the media content service provider. In other aspects, the media file may be further protected by including a watermark in the shared speech-grade media file or limiting the number of allowable “plays” on the receiving device.

In some aspects, the M2-Peer communication module may include the media segmentor 32, in lieu of including the segmentor 32 in some other module, such as the media content player module 26. In such aspects, the media segmentor 32 may be implemented either before the audio portion is encoded in speech-format or, alternatively, after the audio portion is encoded in speech-format.

The M2-Peer communication module 34 also includes a communication mechanism 38 operable for communicating the speech-formatted segments of the media file to the one or more designated share recipients.

Computer platform 60 may further include communications module 68 embodied in hardware, firmware, software, and combinations thereof, that enables communications among the various components of the wireless communication device 10, as well as between the communication device 10 and wireless network 18 and M2-Peer network 14. In described aspects, the communication module enables the communication of all correspondence between the first wireless communication device 10, the second wireless communication device 12 and the media content server 16. The communication module 68 may include the requisite hardware, firmware, software and/or combinations thereof for establishing a wireless or wired network communication connection.

Additionally, communication device 10 has input mechanism 70 for generating inputs into communication device, and output mechanism 72 for generating information for consumption by the user of the communication device. For example, input mechanism 76 may include a mechanism such as a key or keyboard, a mouse, a touch-screen display, a microphone, etc. In certain aspects, the input mechanisms 76 provides for user input to activate and interface with an application, such as the media player module 26 on the communication device. Further, for example, output mechanism 72 may include a display, an audio speaker, a haptic feedback mechanism, etc. In the illustrated aspects, the output mechanism may include a display and an audio speaker operable to display video content and audio content; respectively, associated with a media content file.

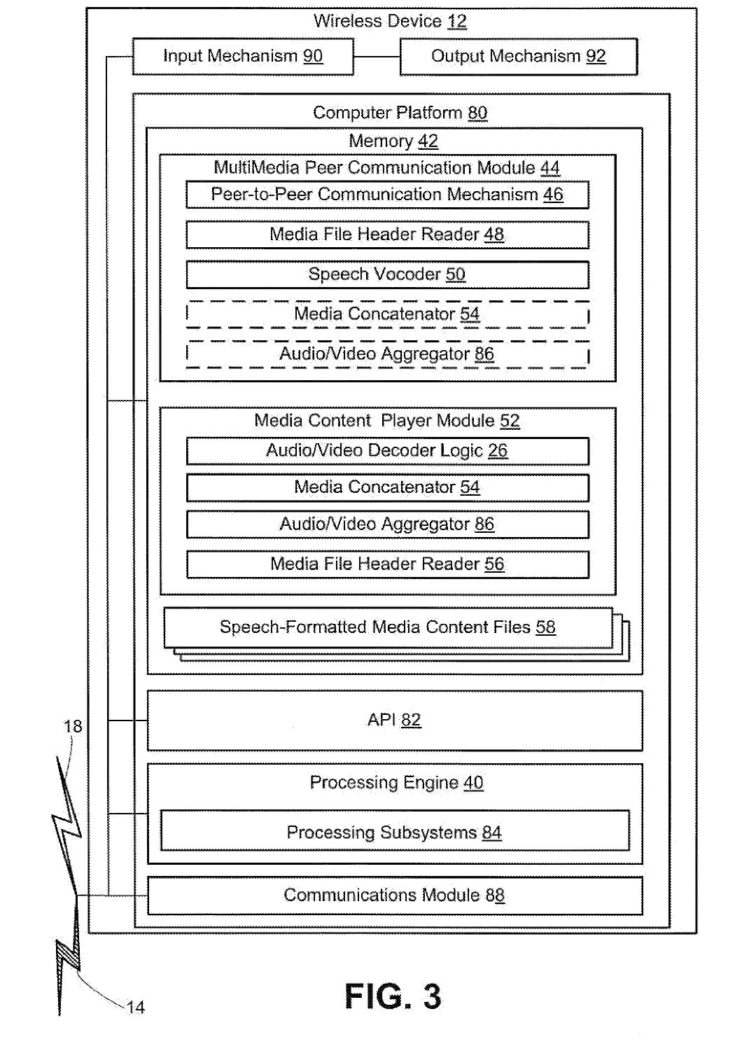

Referring to FIG. 3, according to one aspect, a block diagram representation of a second wireless communication device 12, otherwise referred to as the receiving or recipient wireless device, operable for receiving shared speech-grade media files via M2-Peer communication is depicted. The wireless communication device 12 may include any type of computerized, communication device, such as cellular telephone, Personal Digital Assistant (PDA), two-way text pager, portable computer, and even a separate computer platform that has a wireless communications portal, and which also may have a wired connection to a network or the Internet. The wireless communication device can be a remote-slave, or other device that does not have an end-user thereof but simply communicates data across the wireless network, such as remote sensors, diagnostic tools, data relays, and the like. The present apparatus and methods can accordingly be performed on any form of wireless communication device or wireless computer module, including a wireless communication portal, including without limitation, wireless modems, PCMCIA cards, access terminals, desktop computers or any combination or sub-combination thereof.

The wireless communication device 12 includes computer platform 80 that can transmit data across a wireless network, and that can receive and execute routines and applications. Computer platform 80 includes memory 42, which may comprise volatile and nonvolatile memory such as read-only and/or random-access memory (RAM and ROM), EPROM, EEPROM, flash cards, or any memory common to computer platforms. Further, memory 42 may include one or more flash memory cells, or may be any secondary or tertiary storage device, such as magnetic media, optical media, tape, or soft or hard disk.

Further, computer platform 80 also includes a processing engine 40, which may be an application-specific integrated circuit (“ASIC”), or other chipset, processor, logic circuit, or other data processing device. Processing engine 40 or other processor such as ASIC may execute an application programming interface (“API”) layer 82 that interfaces with any resident programs, such as media player module 52 and/or M2-peer communication module 44, stored in the memory 42 of the wireless device 12. API 82 is typically a runtime environment executing on the respective wireless device. One such runtime environment is Binary Runtime Environment for Wireless® (BREW®) software developed by Qualcomm, Inc., of San Diego, Calif. Other runtime environments may be utilized that, for example, operate to control the execution of applications on wireless computing devices.

Processing engine 40 includes various processing subsystems 84 embodied in hardware, firmware, software, and combinations thereof, that enable the functionality of communication device 12 and the operability of the communication device on a wireless network. For example, processing subsystems 84 allow for initiating and maintaining communications, and exchanging data, with other networked devices. In aspects in which the second wireless communication device 12 is defined as a cellular telephone the communications processing engine 40 may additionally include one or a combination of processing subsystems 84, such as: sound, non-volatile memory, file system, transmit, receive, searcher, layer 1, layer 2, layer 3, main control, remote procedure, handset, power management, digital signal processor, messaging, call manager, Bluetooth® system, Bluetooth® LPOS, position engine, user interface, sleep, data services, security, authentication, USIM/SIM, voice services, graphics, USB, multimedia such as MPEG, GPRS, etc (all of which are not individually depicted in FIG. 2 for the sake of clarity). For the disclosed aspects, processing subsystems 84 of processing engine 40 may include any subsystem components that interact with the media player module 52 and/or the M2-Peer communication module 44 on computer platform 80.

The memory 42 of computer platform 80 includes an M2-Peer communication module 44. The M2-Peer communication module includes a communication mechanism 46 operable for receiving and communicating M2-Peer communications, including communications that include speech-formatted segments of media files. As such, the M2-Peer communication module 44 included in the second wireless communication device 12 may include any and all of the components, logic and functionality exhibited by the M2-Peer communication module 34 discussed in relation to the first wireless communication device 10.

The M2-Peer communication module 44 additionally may include a header reader 48 operable for reading and interpreting the information included in the M2-Peer communication headers. The header information may include identification that recognizes the M2-Peer communication as including a segment of a media file, a media file segment sequence identifier, the speech format used to encode the segment and the like. By identifying the communication as including a segment of a media file, the M2-Peer communication module recognizes that the file needs to be communicated to the media player module 52 for subsequent concatenation of the segments and/or media file consumption/playing. The header reader 48 may also be operable for identifying other information related to the media file, such as advertising information that may be displayed or otherwise presented in conjunction with the consumption/playing of the media file.

The M2-Peer communication module 44 may include speech vocoder 50 operable for decoding the speech-formatted audio segments of the media file. The speech vocoder 50 may be configured to provide decoding of one or more speech-format codes and, at a minimum, decoding of the speech format used by the communicating/sharing wireless communication device 10. The decoding of the audio segments results in speech-grade, pulse code modulation segments (e.g., mini-clips).

In some aspects, the M2-Peer communication module 44 may include media concatenator 54 and audio/video aggregator 86. In alternate embodiments, these components may be included within media player module 52 or in another module or application stored in memory 42. The media concatenator 54 is operable for assembling the audio segments and, in some aspects in which the media file includes video, video segments of the media file in sequence to compose the speech-grade media content files 58. The audio/video aggregator 86 is implemented in those aspects in which the media file includes both audio and video portions that have been segregated out at the communicating/sharing wireless communication device 10. The audio/video aggregator is operable for aggregating/synthesizing the audio and video portions to form the composite media file.

The memory 42 of second wireless communication device 12 may additionally include a media player module 52 operable for receiving and consuming/playing speech-grade media files. As previously noted, the media player module 52 may include media concatenator 54 and audio/video aggregator 86. The media player module 52 may additionally include a header reader 56 that is operable for identifying a sequence identifier included within the header that is used by the concatenator 54 in assembling the media file in proper sequence. The header reader 56 may additionally be operable for identifying additional information related to the media file, such as advertising information, in the form of media file service provider links or the like, that may be displayed or otherwise presented to the user during the consumption/playing of the speech-grade media file 58 at the second wireless communication device 12.

Additionally, the media content player module 52 may include audio/video decoder logic 26 that is operable for decoding the compressed audio signal and, when applicable, video signal of the media files 58 prior to concatenation or aggregation. In many aspects, the decoding of the compressed media content file will occur at the communicating/sharing wireless communication device 10, obviating the need to perform the audio/video compression decoding at the second wireless communication device 12. As previously noted, FIG. 8, which will be discussed in detail infra. provides a flow diagram of a method, which provides for compressed audio decoding at the second wireless communication device.

Computer platform 60 may further include communications module 88 embodied in hardware, firmware, software, and combinations thereof, that enables communications among the various components of the wireless communication device 12, as well as between the communication device 12 and wireless network 18 and M2-Peer network 14. In described aspects, the communication module enables the communication of all correspondence between the first wireless communication device 10, the second wireless communication device 12 and the media content server 16. The communication module 88 may include the requisite hardware, firmware, software and/or combinations thereof for establishing a wireless or wired network communication connection.

Additionally, communication device 12 has input mechanism 90 for generating inputs into communication device, and output mechanism 92 for generating information for consumption by the user of the communication device. For example, input mechanism 90 may include a mechanism such as a key or keyboard, a mouse, a touch-screen display, a microphone, etc. In certain aspects, the input mechanisms 90 provides for user input to activate and interface with an application, such as the media player module 44 on the communication device. Further, for example, output mechanism 92 may include a display, an audio speaker, a haptic feedback mechanism, etc. In the illustrated aspects, the output mechanism may include a display and an audio speaker operable to display video content and audio content; respectively, associated with a media content file.

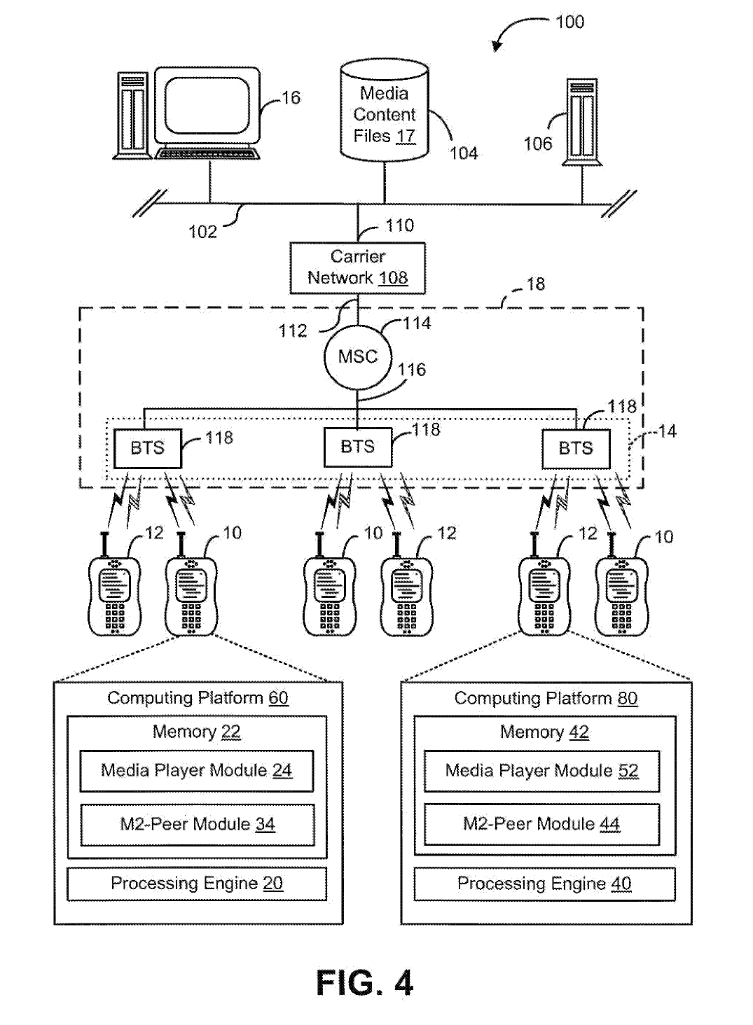

Referring to FIG. 4, in one aspect, wireless communication devices 10 and 12 comprise a wireless communication device, such as a cellular telephone. In present aspects, wireless communication devices are configured to communicate via the cellular network 100 and the M2-Peer network 14. The cellular network 100 provides wireless communication devices 10 and 12 the capability to receive media files from media content server 16 and the M2-Peer network 14 provides wireless communication devices 10 and 12 the capability to share speech-grade media content files. The cellular telephone network 80 may include wireless network 18 connected to a wired network 102 via a carrier network 108. FIG. 4 is a representative diagram that more fully illustrates the components of a wireless communication network and the interrelation of the elements of one aspect of the present system. Cellular telephone network 100 is merely exemplary and can include any system whereby remote modules, such as wireless communication devices 10, 12 communicate over-the-air between and among each other and/or between and among components of a wireless network 18, including, without limitation, wireless network carriers and/or servers.

In network 100, network device 16, such as a media content provider server, can be in communication over a wired network 102 (e.g. a local area network, LAN) with a separate network database 104 for storing the media content files 17. Further, a data management server 106 may be in communication with network device 16 to provide post-processing capabilities, data flow control, etc. Network device 16, network database 104 and data management server 106 may be present on the cellular telephone network 100 with any other network components that are needed to provide cellular telecommunication services. Network device 16, and/or data management server 106 communicate with carrier network 108 through a data links 110 and 112, which may be data links such as the Internet, a secure LAN, WAN, or other network. Carrier network 108 controls messages (generally being data packets) sent to a mobile switching center (“MSC”) 114. Further, carrier network 108 communicates with MSC 114 by a network 112, such as the Internet, and/or POTS (“plain old telephone service”). Typically, in network 112, a network or Internet portion transfers data, and the POTS portion transfers voice information. MSC 114 may be connected to multiple base stations (“BTS”) 118 by another network 116, such as a data network and/or Internet portion for data transfer and a POTS portion for voice information. BTS 118 ultimately broadcasts messages wirelessly to the wireless communication devices 10 and 12, by short messaging service (“SMS”), or other over-the-air methods.

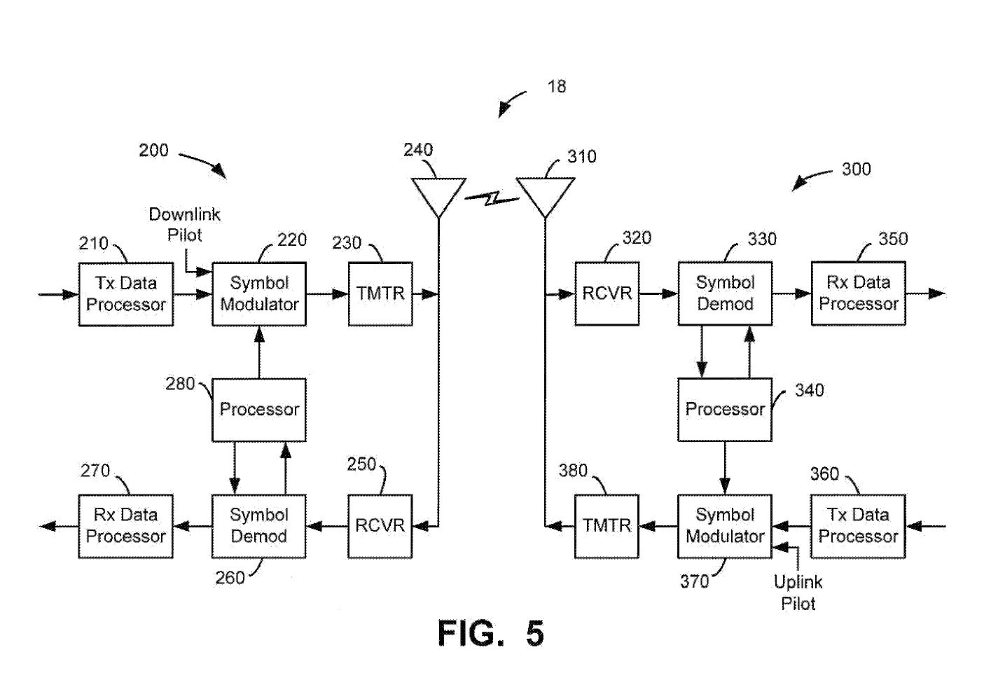

FIG. 5 is block diagram illustration of a wireless network 18 environment that can be employed in accordance with an aspect. The wireless network 18 may be utilized in present aspects to download or otherwise receive media files 17 from network entities, such as media content providers and the like. The wireless network shown in FIG. 5 may be implemented in an FDMA environment, an OFDMA environment, a CDMA environment, a WCDMA environment, a TDMA environment, an SDMA environment, or any other suitable wireless environment. While, for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

The wireless network 18 includes an access point 200 and a wireless communication device 300. Access point 200 includes a transmit (TX) data processor 210 that receives, formats, codes, interleaves, and modulates (or symbol maps) traffic data and provides modulation symbols (“data symbols”). The TX data processor 210 is in communication with symbol modulator 220 that receives and processes the data symbols and pilot symbols and provides a stream of symbols. Symbol modulator 220 is in communication with transmitter unit (TMTR) 230, such that symbol modulator 220 multiplexes data and pilot symbols and provides them to transmitter unit (TMTR) 230. Each transmit symbol may be a data symbol, a pilot symbol, or a signal value of zero. The pilot symbols may be sent continuously in each symbol period. The pilot symbols can be frequency division multiplexed (FDM), orthogonal frequency division multiplexed (OFDM), time division multiplexed (TDM), frequency division multiplexed (FDM), or code division multiplexed (CDM).

TMTR 230 receives and converts the stream of symbols into one or more analog signals and further conditions (e.g., amplifies, filters, and frequency upconverts) the analog signals to generate a downlink signal suitable for transmission over the wireless channel. The downlink signal is then transmitted through antenna 240 to the terminals.

At wireless communication device 300, antenna 310 receives the downlink signal and provides a received signal to receiver unit (RCVR) 320. Receiver unit 320 conditions (e.g., filters, amplifies, and frequency downconverts) the received signal and digitizes the conditioned signal to obtain samples. Receiver unit 320 is in communication with symbol demodulator 330 that demodulates the conditioned received signal. Symbol demodulator 330 is in communication with processor 340 that receives pilot symbols from symbol demodulator 330 and performs channel estimation on the pilot symbols. Symbol demodulator 330 further receives a frequency response estimate for the downlink from processor 340 and performs data demodulation on the received data symbols to obtain data symbol estimates (which are estimates of the transmitted data symbols). The symbol demodulator 330 is also in communication with RX data processor 350, which receives data symbol estimates from the symbol demodulator and demodulates (e.g., symbol demaps), deinterleaves, and decodes the data symbol estimates to recover the transmitted traffic data. The processing by symbol demodulator 330 and RX data processor 350 is complementary to the processing by symbol modulator 220 and TX data processor 210, respectively, at access point 200.

On the uplink, a TX data processor 360 processes traffic data and provides data symbols. The TX data processor is in communication with symbol modulator 370 that receives and multiplexes the data symbols with pilot symbols, performs modulation, and provides a stream of symbols. The symbol modulator 370 is in communication with transmitter unit 380, which receives and processes the stream of symbols to generate an uplink signal, which is transmitted by the antenna 310 to the access point 200.

At access point 200, the uplink signal from wireless communication device 200 is received by the antenna 240 and processed by a receiver unit 250 to obtain samples. The receiver unit 250 is in communication with symbol demodulator 260 then processes the samples and provides received pilot symbols and data symbol estimates for the uplink. The symbol demodulator 260 is in communication with RX data processor 270 that processes the data symbol estimates to recover the traffic data transmitted by wireless communication device 200. The symbol demodulator is also in communication with processor 280 that performs channel estimation for each active terminal transmitting on the uplink. Multiple terminals may transmit pilot concurrently on the uplink on their respective assigned sets of pilot subbands, where the pilot subband sets may be interlaced.

Processors 280 and 340 direct (e.g., control, coordinate, manage, etc.) operation at access point 200 and wireless communication device 300, respectively. Respective processors 280 and 340 can be associated with memory units (not shown) that store program codes and data. Processors 280 and 340 can also perform computations to derive frequency and impulse response estimates for the uplink and downlink, respectively.

For a multiple-access system (e.g., FDMA, OFDMA, CDMA, TDMA, etc.), multiple terminals can transmit concurrently on the uplink. For such a system, the pilot subbands may be shared among different terminals. The channel estimation techniques may be used in cases where the pilot subbands for each terminal span the entire operating band (possibly except for the band edges). Such a pilot subband structure would be desirable to obtain frequency diversity for each terminal. The techniques described herein may be implemented by various means. For example, these techniques may be implemented in hardware, software, or a combination thereof. For a hardware implementation, the processing units used for channel estimation may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes may be stored in memory unit and executed by the processors 280 and 340.

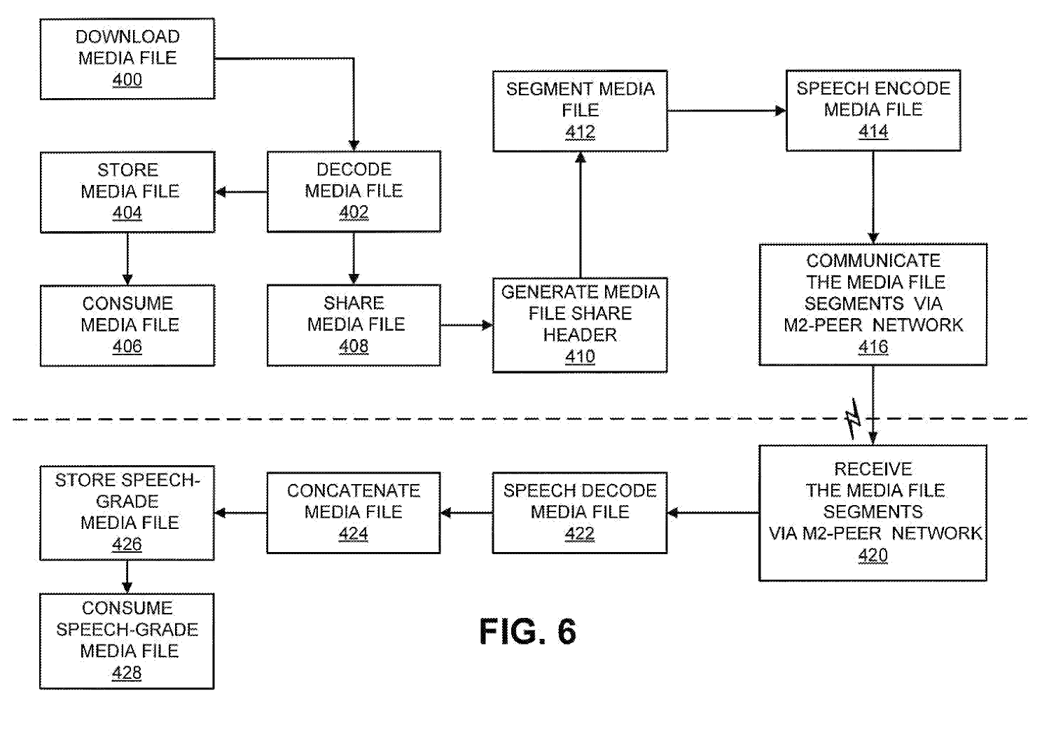

Referring to FIG. 6, a flow diagram of a method for sharing a media file amongst wireless communication devices in an M2-Peer network is depicted. At Event 400, a first wireless communication device wirelessly downloads or otherwise receives a media file, such as an audio/song file, a video file, a gaming file or the like. In some aspects, the wireless device wirelessly downloads the media file from a media content supplier. In alternate aspects, the wireless device may receive the media file via USB transfer from a wired or wireless computing device, via transfer from removable flash memory device or the like. The downloaded media file is typically received in a compressed format. For example, audio/song files may be received in MP3, AAC or some other compressed audio format that requires decompression/decoding. Thus, at Event 402, the downloaded media file is decoding, resulting in a digital signal, such as Pulse Code Modulation Signal (PCM) or the like. At Event 404, the media file may be stored in first wireless communication device memory and, at Event 406, the media file may be consumed/executed/played on the first wireless communication device. Alternatively, a user may choose to consume/execute/play the media file without storing the media file at the wireless device.

At Event 408, the media file is designated for sharing by the device user. In some aspects, the wireless device will provide the user an option to share the media file. For example, the media player module may be configured to offer a menu item associated with sharing media files or a pop-up window may be configured to query the user as to a desire to share the media file. In addition to designating a media file for sharing, the media player module or some other module will characteristically provide for the user to choose one or more parties to whom the media file will be shared. In general, the media file may be shared with a party that is associated with a device equipped to receive wireless M2-Peer communications and being configured to recognize the communications as including a media file and perform requisite post-processing.

At Event 410, once the media file has been designated for sharing, M2-Peer communication header information is generated. The header information may include, but is not limited to, a media file identifier, speech codec identification, advertising information associated with the media file, segmentation sequencing information and the like. The header information will be attached to each M-2 Peer communication that includes a segment of the media file.

At Event 412, the media file is segmented into media clips that are sized according to the limitations of the M2-Peer communication network. Typically, the M2-Peer communication network is limited to the communication of audio clips that are a maximum of about 60 seconds to about 90 seconds. Thus, the media file requires proper segmentation prior to M2-Peer communication. For example, the segmentation of an approximately five minute audio file may result five or more in media clips that are each less than 60 seconds in duration. If the media file includes a video portion, the media clips may be significantly shorter in length.

At Event 414, the media file is speech-encoded using an appropriate speech codec such as QCELP, iLBC, EVCR, Speex or the like. Speech encoding of the media file ensures that the recipient of the shared file is only able to consume/execute/play the media file in a speech-grade audio form that is a lesser audio quality than the commercial-grade media file. It is noted that while the illustrated aspect describes the segmentation process (Event 412) as occurring prior to the speech-encoding process (Event 414), in other aspects the segmentation process (Event 412) may occur after the speech-encoding process (Event 414).

At Event 416, the speech-encoded segments of the media file are communicated to the designated wireless communication devices via M2-Peer communication. Each M2-Peer communication will include at least one, and typically not more than one, segment of the media file. It should be noted that prior to communication it may be necessary to add additional information to the header, such as segment sequencing information, speech-encoding information and the like.

At Event 420, the designated share recipient receives, at a second wireless communication device, the M2-Peer communications that include individual segments of the media file. The M2-Peer communication module of the second wireless configuration device that receives the communications is configured to read the header information for the purpose of identifying the M2-Peer communication as including a media file segment. Proper identification of the communication instructs the M2-Peer communication module to forward the media file segments to an appropriate media player module. At Event 422, media file segments are decoded using the same or similar codec used to speech-encode the media file at the sharing device. Decoding of the media file segments results in digital signal media clips, such as PCM media clips or the like.

At Event 424, the segmented media clips are concatenated to form the composite media file, which characteristically has speech-grade audio. Concatenation involves recognizing the sequence identifier associated with each segment of the media file and accordingly assembling the media file in proper sequence. In the same regard as the segmentation process performed at the first wireless communication device, the concatenation process (Event 424) may occur after the speech decode process (Event 422) or, in alternate aspects, the concatenation process (Event 424) may occur prior to the speech-decode process (Event 422).

At Event 426, the speech-grade media file is stored in second wireless communication device memory and, at Event 428, the speech-grade media file is consumed/executed/played at the command of the device user. In alternate aspects, the speech-grade media file may be consumed/executed/played at the second wireless communication device without storing the media file in device memory.

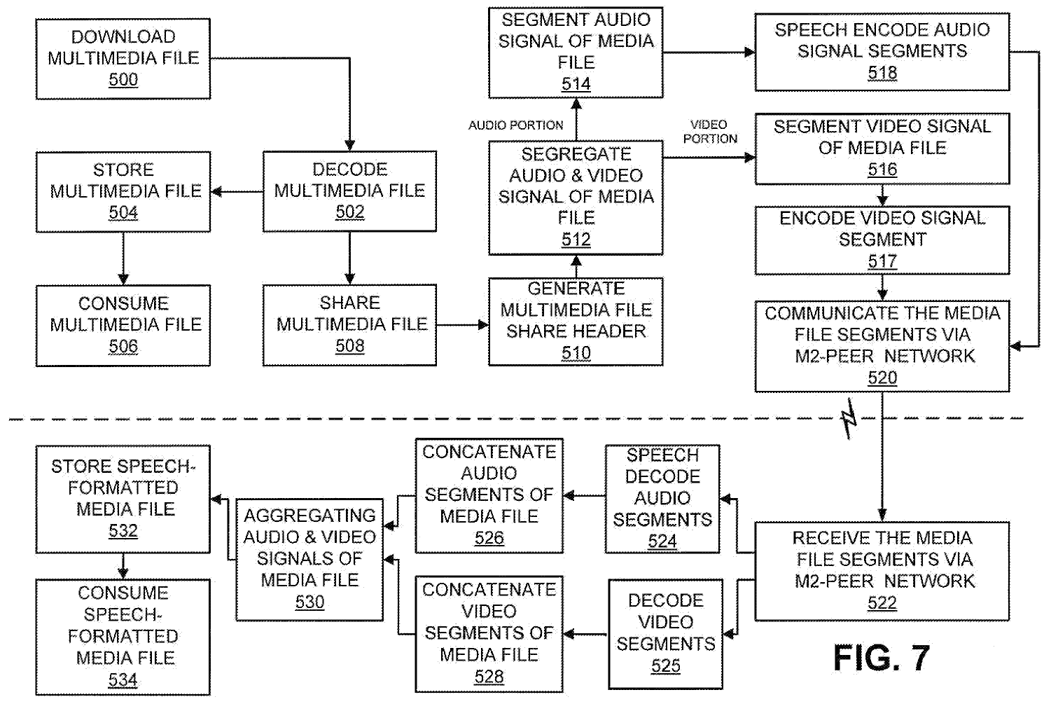

Referring to FIG. 7, a flow diagram of a method for sharing a multimedia file amongst wireless communication devices in an M2-Peer network is depicted. In the illustrated, the multimedia file includes both audio and video components. At Event 500, a first wireless communication device wirelessly downloads or otherwise receives a multimedia file, such as a video file, a gaming file or the like. In some aspects, the wireless device wirelessly downloads the multimedia file from a media content supplier. In alternate aspects, the wireless device may receive the multimedia file via USB transfer from a wired or wireless computing device, via transfer from removable flash memory device or the like. The downloaded multimedia file is typically received in a compressed format. For example, video files may be received in Motion Picture Experts Group (MPEG), Advanced Systems Format (ASF), Windows Media Video (WMV) or some other compressed video format that requires decompression/decoding. Thus, at Event 502, the downloaded multimedia file is decoding, resulting in a digital signal, such as Pulse Code Modulation Signal (PCM) or the like. At Event 504, the multimedia file may be stored in first wireless communication device memory and, at Event 506, the multimedia file may be consumed/executed/played on the first wireless communication device. Alternatively, a user may choose to consume/execute/play the multimedia file without storing the multimedia file at the wireless device.

At Event 508, the multimedia file is designated for sharing by the device user. In some aspects, the wireless device will provide the user an option to share the multimedia file. For example, the media player module may be configured to offer a menu item associated with sharing multimedia files or a pop-up window may be configured to query the user as to a desire to share the multimedia file. In addition to designating a multimedia file for sharing, the media player module or some other module will characteristically provide for the user to choose one or more parties to whom the multimedia file will be shared. In general, the multimedia file may be shared with a party that is associated with a device equipped to receive wireless M2-Peer communications and being configured to recognize the communications as including a multimedia file and perform requisite post-processing.

At Event 510, once the multimedia file has been designated for sharing, M2-Peer communication header information is generated. The header information may include, but is not limited to, a multimedia file identifier, speech codec identification, advertising information associated with the multimedia file, segmentation sequencing information and the like. The header information will be attached to each M-2 Peer communication that includes a segment of the multimedia file.

At Event 512, the audio and video portions of the multimedia file are segregated for subsequent speech-encoding of the audio portion of the multimedia file. At Event 514, the audio signal of the multimedia file is segmented into audio clips and, at Event 516 the video signal of the multimedia file is segmented into video clips. The segments are sized according to the limitations of the M2-Peer communication network.

At Event 518, the audio segments of multimedia file are speech-encoded using an appropriate speech codec such as QCELP, iLBC, EVCR, Speex or the like. At Event 517, the video segments of the multimedia file are encoded using a video format that is suitable to M2-peer network communication. It is noted that while the illustrated aspect describes the audio segmentation process (Event 514) as occurring prior to the speech-encoding process (Event 518), in other aspects the audio segmentation process (Event 518) may occur after the speech-encoding process (Event 514). The video segmentation process (Event 516) may occur prior to the encoding process (Event 517) or, in other aspects, the video segmentation process (Event 516) may occur after the video encoding process (Event 517). At Event 520, the speech-encoded audio segments and the video segments of the multimedia file are communicated to the designated wireless communication devices via M2-Peer communication. Each M2-Peer communication will include at least one, and typically not more than one, audio or video segment of the multimedia file. It should be noted that prior to communication it may be necessary to add additional information to the header, such as video and audio segment sequencing information, speech-encoding information and the like.

At Event 522, the designated share recipient receives, at a second wireless communication device, the M2-Peer communications that include individual audio or video segments of the multimedia file. The M2-Peer communication module of the second wireless configuration device that receives the communications is configured to read the header information for the purpose of identifying the M2-Peer communication as including a multimedia file segment. Proper identification of the communication instructs the M2-Peer communication module to forward the multimedia file segments to an appropriate media player module. At Event 524, audio segments are decoded using the same or similar codec used to speech-encode the audio portion of the multimedia file at the sharing device. At Event 525, the video segments are decoded using the same or similar codec used to video encode the video portion of the multimedia file at the sharing device. Decoding of the multimedia file segments results in digital signal media clips, such as PCM media clips or the like.

At Event 526, the segmented audio clips are concatenated and, at Event 528, the segmented video clips are concatenated to form the composite audio and video portions of the multimedia file. The concatenation processes (Events 526 and 528) may occur after the decode process (Event 524) or, in alternate aspects, the concatenation processes (Events 526 and 528) may occur prior to the decode process (Event 524).

At Event 530, the audio and video portions of the multimedia file are aggregated/synthesized to form the composite multimedia file. The aggregation of the audio and video portions (Event 530) may occur after or prior to the concatenation processes (Events 526 and 528) and/or the decode process (Event 524).

At Event 532, the speech-grade multimedia file is stored in second wireless communication device memory and, at Event 534, the speech-grade multimedia file is consumed/executed/played at the command of the device user. In alternate aspects, the speech-grade multimedia file may be consumed/executed/played at the second wireless communication device without storing the multimedia file in device memory.

Referring to FIG. 8, a flow diagram of a method for sharing a media file amongst wireless communication devices in an M2-Peer network is depicted. In the illustrated aspect, initial decompression/decoding of the downloaded media file is postponed until the shared media file is received by the second wireless communication device At Event 600, a first wireless communication device wirelessly downloads or otherwise receives a media file, such as an audio/song file, a video file, a gaming file or the like. In some aspects, the wireless device wirelessly downloads the media file from a media content supplier. In alternate aspects, the wireless device may receive the media file via USB transfer from a wired or wireless computing device, via transfer from removable flash memory device or the like.

At Event 602, the media file is designated for sharing by the device user. In some aspects, the wireless device will provide the user an option to share the media file. For example, the media player module may be configured to offer a menu item associated with sharing media files or a pop-up window may be configured to query the user as to a desire to share the media file. In addition to designating a media file for sharing, the media player module or some other module will characteristically provide for the user to choose one or more parties to whom the media file will be shared. In general, the media file may be shared with a party that is associated with a device equipped to receive wireless M2-Peer communications and being configured to recognize the communications as including a media file and perform requisite post-processing.

At Event 604, once the media file has been designated for sharing, M2-Peer communication header information is generated. The header information may include, but is not limited to, a media file identifier, speech codec identification, advertising information associated with the media file, segmentation sequencing information and the like. The header information will be attached to each M-2 Peer communication that includes a segment of the media file.

At Event 606, the media file is segmented into media clips that are sized according to the limitations of the M2-Peer communication network. Thus, the media file requires proper segmentation prior to M2-Peer communication. At Event 608, the media file is speech-encoded using an appropriate speech codec such as QCELP, iLBC, EVCR, Speex or the like. Speech encoding of the media file ensures that the recipient of the shared file is only able to consume/execute/play the media file in a speech-grade audio form that is a lesser audio quality than the commercial-grade media file. It is noted that while the illustrated aspect describes the segmentation process (Event 606) as occurring prior to the speech-encoding process (Event 608), in other aspects the segmentation process (Event 606) may occur after the speech-encoding process (Event 608).

At Event 610, the speech-encoded segments of the media file are communicated to the designated wireless communication devices via M2-Peer communication. Each M2-Peer communication will include at least one, and typically not more than one, segment of the media file. It should be noted that prior to communication it may be necessary to add additional information to the header, such as segment sequencing information, speech-encoding information and the like.

At Event 612, the designated share recipient receives, at a second wireless communication device, the M2-Peer communications that include individual segments of the media file. The M2-Peer communication module of the second wireless configuration device that receives the communications is configured to read the header information for the purpose of identifying the M2-Peer communication as including a media file segment. Proper identification of the communication instructs the M2-Peer communication module to forward the media file segments to an appropriate media player module. At Event 614, media file segments are decoded using the same or similar codec used to speech-encode the media file at the sharing device. Decoding of the media file segments results in a compressed format media file. At Event 616, the compressed format media file is decompressed/decoded resulting in a digital signal format, such as PCM signal format.

At Event 618, the segmented media clips are concatenated to form the composite media file, which characteristically has speech-grade audio. As previously noted, the concatenation process (Event 618) may occur after the speech decode process (Event 614) and/or decompression/decode process (Event 616) or, in alternate aspects, the concatenation process (Event 618) may occur prior to the speech-decode process (Event 614) and/or decompression/decode process (Event 616).

At Event 620, the speech-grade media file is stored in second wireless communication device memory and, at Event 622, the speech-grade media file is consumed/executed/played at the command of the device user. In alternate aspects, the speech-grade media file may be consumed/executed/played at the second wireless communication device without storing the media file in device memory.

Referring to FIG. 7, a flow diagram of a method for preparing a media file for wireless device to wireless device communication is depicted. At Event 700, a first wireless device receives a media file. The media file, which may include an audio file, a video file, a game file or any other multimedia file, may be received by wireless communication, by universal serial bus (USB) connection with another device or storage unit, by removable flash memory or through any other acceptable reception mechanisms. In instances in which the media file is received in a compressed audio and/or video format, receiving the media file may also include decoding/decompressing the audio and/or video format. Examples of compressed audio formats include, but are not limited to, MP3, AAC, HE-AAC, ITU-T G.711, ITU-T G.722, ITU-T G.722.1, ITU-T G.722.2, ITU-T G.723, ITU-T G.723.1, ITU-T G.726, ITU-T G.729, ITU-T G.729a, FLAC, Ogg, Theora, Vorbis, ATRAC3, AC.3, AIFF-C and the like. Example of compressed video formats include, but are not limited to, MPEG-1, MPEG-2, Quicktime™, Real Video, Windows™ Media Format (WMV) and the like.

At Event 710, the audio signal of the media file is segmented into two or more audio segments. In those aspects in which the media file includes an audio portion and a video portion, the video portion may also require segmenting into two or more video segments. In some aspects, in which the media file includes an audio portion and a video portion, the audio and video portions may require segregation prior to segmenting the audio and video portions.

At Event 720, the audio signal of the media file is encoded in a speech format. The encoding of the audio signal in speech-format may occur prior to or after the segmenting of the audio signal into two or more audio segments. Speech-format will generally be characterized as an audio format having the bandwidth range of about 20 Hz to about 20 kHz. Examples of speech codecs used to format the audio signal include, but are not limited to, QCELP (Qualcomm® Code Excited Linear Prediction), EVCR (Enhanced Variable Rate Codec), iLBC (Internet Low Bit Rate), Speex and the like. In those instances in which the media includes a video portion, the video portion may require video compression encoding into a standard video compression format. The encoding of the video signal may occur prior to or after the segmenting of the video signal into two or more video segments.

At optional Event 730, the audio segments of the speech-formatted media file are communicated, individually, via a multimedia peer (M2-Peer) communication network. In instances in which the media file includes a video portion, the video segments of the speech-formatted media file are also communicated, individually, via the M2-Peer communication network. In this regard, the individual communication of each segment provides for reliable delivery of the media file to one or more wireless communications devices that are in M2-Peer communication with the sharing device.

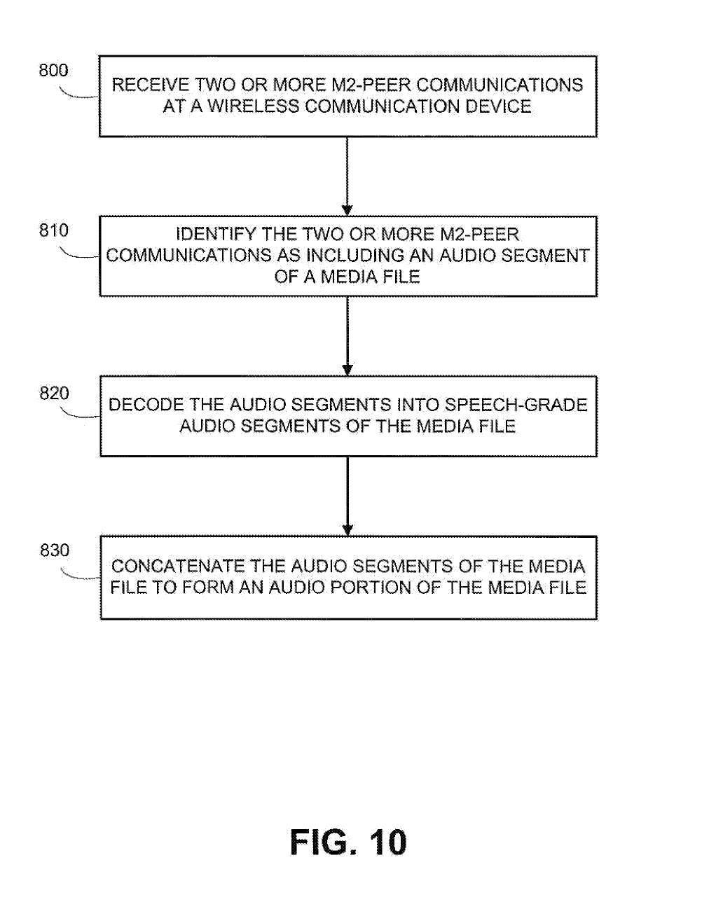

Referring to FIG. 10, a flow diagram of a method for receiving a segmented and speech-formatted media file is depicted. At Event 800, a wireless device receives two or more M2-Peer communications that each include a segment of a media file. At Event 810, the wireless device identifies at least two of the two or more M2-Peer communications as including an audio segment of a media file. In alternate aspects, the wireless device may identify at least two of the two or more M2-Peer communications as including a video segment of the media file. Identification of the M2-Peer communications may involve reading the header information associated with the M2-Peer communications, which indicates that the communications include audio and/or video segments of media file. In this regard, the identification by the receiving wireless device alerts the device to further process the communications as segments of the media file.

At Event 820, the audio segments are decoded/decompressed resulting in speech-grade audio segments. As previously noted, the speech-grade audio segments may have a bandwidth range of about 20 Hz to about 20 kHz. The decode/decompression technique will mirror the encode/compression technique used at the sharing device to speech-encode the audio segments of the media file.

At Event 830, the audio segments are concatenated to form the composite audio portion of the media file. In aspects in which the media file includes a video portion, the video segments of the media file may be concatenated to form the composite video portion of the media file and the video and audio portions may be aggregated to form the composite media file. The concatenated and, in some aspects, aggregated media file can be stored and/or consumed/played at the wireless device.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine-readable medium and/or computer readable medium.

While the foregoing disclosure shows illustrative aspects and/or embodiments, it should be noted that various changes and modifications could be made herein without departing from the scope of the described aspects and/or embodiments as defined by the appended claims. Furthermore, although elements of the described embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

Thus, the described aspects provide for systems, methods, device and apparatus that provide for communication, e.g., sharing, of media files between wireless communication devices using a Multi-Media Peer (M2-Peer) communication network. A media file is speech-encoded on a first wireless communication device and subsequently communicated, via M2-Peer, to a second communication device, which decodes the speech-encoded media file for subsequent playback capability on the second communication device. Since M2-Peer communication is limited in terms of the length of the file that can be communicated the media file may require segmentation at the first communication device prior to communicating the media file to the second communication device, which, in turn, will require concatenation/assembly of the segments prior to playing the media file. As such, present aspects provide for instantaneous sharing of media files amongst wireless communication devices. By degrading the audio portion of the media file to a speech-grade quality, the files may be shared without comprising any intellectual property rights associated with the media file.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for preparing a media file for wireless device to wireless device communication, comprising:
receiving a media file at a first wireless communication device;
segmenting an audio signal of the media file into two or more audio segments; and
encoding the audio signal of the media file in speech format.

2. The method of claim 1, further comprising communicating, individually, each audio segment of the speech-formatted media file using Multi-Media Peer (M2-Peer) communication.

3. The method of claim 1, wherein segmenting occurs prior to encoding the audio signal of the media file in a speech format.

4. The method of claim 1, wherein segmenting occurs after encoding the audio signal of the media file in a speech format.

5. The method of claim 1, further comprising segregating an audio signal and a video signal of the media file.

6. The method of claim 5, further comprising segmenting the video signal of the media file into two or more video segments.

7. The method of claim 6, further comprising communicating, individually, each video segment of the media file using M2-Peer communication.

8. The method of claim 1, wherein receiving a media file further comprises:
receiving a media file in a compressed digital audio format; and
decoding the compressed digital audio format.

9. The method of claim 8, wherein decoding the compressed digital audio format further comprises decoding the compressed digital audio format prior to segmenting an audio signal of the media file into two or more segments.

10. The method of claim 8, wherein receiving a media file in a compressed digital audio format further comprises a digital audio format chosen from the group consisting of MP3, AAC, AAC+, enhanced AAC+, HE-AAC, ITU-T G.711, ITU-T G.722, ITU-T G.722.1, ITU-T G.722.2, ITU-T G.723, ITU-T G.723.1, ITU-T G.726, ITU-T G.729, ITU-T G.729a, FLAC, Ogg, Theora, Vorbis, ATRAC3, AC3 and AIFF-C.

11. The method of claim 1, further comprising designating the received media file as a share file.

12. The method of claim 1, further comprising generating header information that is attached to each segment of the media file prior to communication.

13. The method of claim 12, wherein the header information includes instructions for recognizing, at the second wireless communication device, that the M2-Peer communication includes the speech-formatted audio signals of a media file.

14. The method of claim 12, wherein the header information includes instructions for accessing, advertisement information associated with the media file.

15. The method of claim 1, wherein encoding the audio signal of the media file in a speech format further comprises selecting a speech format chosen from the group consisting of QCELP, EVCR, iLBC, and Speex.

16. The method of claim 1, wherein encoding the audio signal of the media file in speech format further comprises encoding the audio signal in a speech format having a bandwidth range of about 20 Hertz to about 20 Kilohertz.

17. The method of claim 1, further comprising applying a digital watermark to the media file.

18. The method of claim 1, further comprising applying a digital watermark to each of the two or more audio segments.

19. At least one processor configured to perform the actions of:
receiving a media file at a first wireless communication device;
segmenting an audio signal of the media file into two or more segments; and
encoding the audio signal of the media file in speech format.

20. A machine-readable medium comprising instructions stored thereon, comprising:
a first set of instructions for receiving a media file at a first wireless communication device;
a second set of instructions for segmenting an audio signal of the media file into two or more audio segments; and
a third set of instructions for encoding the audio signal of the media file in a speech format.

21. A wireless communication device, the device comprising:
a computer platform including at least one processor and a memory;
a media player module stored in the memory and executable by the processor, wherein the media player module is operable for receiving a media file;
a media file segmentor stored in the memory and executable by the processor, wherein the media file segmentor is operable for segmenting an audio signal of the media file into two or more audio segments; and
a Multi-Media Peer (M2-Peer) communication module stored in the memory and executable by the processor, wherein the M2-Peer module includes a speech vocoder operable for encoding the audio signal of the media file into a speech format and a communications mechanism operable for communicating the two or more speech-formatted audio segments to a second wireless communication device.

22. The wireless communication device of claim 21, wherein the media player module further comprises an audio file codec operable for audio decoding a compressed media file.

23. The wireless communication device of claim 21, wherein the media file segmentor is included in the media player module.

24. The wireless communication device of claim 21, wherein the media file segmentor is included within the M2-Peer communication module.

25. The wireless communication device of claim 21, further comprising an audio/video segregator stored in the memory and executable by the processor, wherein the audio/video segregator is operable for segregating the media file into an audio signal and a video signal.

26. The wireless communication device of claim 25, wherein the media file segmentor is further operable for segmenting the video signal into two or more video segments.

27. The wireless communication device of claim 26, wherein the communication mechanism of the M2-Peer communication module is further operable for communicating the two or more video segments to a second wireless communication device.

28. The wireless communication device of claim 21, wherein the media player module further includes a media share header generator operable for generating header information to be included with the communicated two or more speech-formatted audio segments.

29. The wireless communication device of claim 28, wherein the media share header generator is further operable for generating header information that includes instructions for recognizing, at the second wireless communication device, that the M2-Peer communication includes a speech-formatted audio segment of a media file.

30. The wireless communication device of claim 28, wherein the media share header generator is further operable for generating header information that includes instructions for accessing advertisement information associated with the media file.

31. A wireless communications device, the device comprising:
means for receiving a media file at a first wireless communication device;
means for segmenting an audio signal of the media file into two or more; and
means for encoding the audio signal of the media file in speech format.

32. A method for receiving a shared media file on a wireless communication device, the method comprising:
receiving two or more Multimedia Peer (M2-Peer) communications at a wireless communication device;
identifying at least two of the two or more M2-Peer communications as including an audio segment of a media file;
decoding the audio segments resulting in speech-grade audio segments of the media file; and
concatenating the audio segments of the media file to form an audio portion of the media file.

33. The method of claim 32, further comprising communicating the concatenated media file to a media player application.

34. The method of claim 32, wherein decoding the audio segments further comprises decoding the audio segments from speech-encoded format to compressed audio format and decoding the compressed audio format to Pulse Code Modulation signals.

35. The method of claim 32, further comprising identifying at least two of the two or more M2-Peer communications as including a video segment of the media file.

36. The method of claim 35, further comprising concatenating the video segments to form a video portion of the media file.

37. The method of claim 35, further comprising aggregating the audio portion and video portion to form the media file.

38. At least one processor configured to perform the actions of:
receiving two or more Multimedia Peer (M2-Peer) communications at a wireless communication device;
identifying the two or more M2-Peer communications as including an audio segment of a media file;
decoding the audio segments resulting in speech-grade audio segments of the media file; and
concatenating the audio segments of the media file to form an audio portion of the media file.

39. A machine-readable medium comprising instructions stored thereon, comprising:
a first set of instructions for receiving two or more Multimedia Peer (M2-Peer) communications at a wireless communication device;
a second set of instructions for identifying the two or more M2-Peer communications as including an audio segment of a media file;
a third set of instructions for decoding the audio segments resulting in speech-grade audio segments of the media file; and
a fourth set of instructions for concatenating the audio segments of the media file to form an audio portion of the media file.

40. A wireless communication device, the device comprising:
a computer platform including at least one processor and a memory; and
a Multi-Media Peer (M2-Peer) communication module stored in the memory and executable by the processor, wherein the wherein the M2-Peer module is operable for receiving two or more M2-Peer communications and identifying the communications as including an audio segment of a media file;
a speech vocoder stored in the memory and executable by the processor, wherein the speech vocoder is operable for decoding the audio segments resulting in speech-grade audio segments of the media file; and
a concatenator stored in the memory and executable by the processor, wherein the concatenator is operable for concatenating the audio segments of the media file to form an audio portion of a media file.

41. The wireless communication device of claim 40, further comprising a media player application that is operable for receiving the speech-grade audio segments of the media file.

42. The wireless communication device of claim 41, wherein the media player application includes the concatenator.

43. The wireless communication device of claim 40, wherein the M2-Peer module further includes an audio file codec operable for decoding a compressed media file.

44. The wireless communication device of claim 40, wherein the M2-Peer module is further operable for identifying the two or more M2-Peer communications as including at least one of a video segment and an audio segment of the media file.

45. The wireless communication device of claim 44, wherein the concatenator is further operable to concatenate the video segments to form a video portion of the media file.

46. The wireless communication device of claim 45, further comprising an aggregator operable for aggregating the audio portion and the video portion to form the media file.

47. The wireless communication device of claim 40, wherein the M2-Peer module is further operable for identifying the two or more M2-Peer communications as including an audio segment of a media file based on recognition of media file-identifying information in a M2-Peer communication header.

48. The wireless communication device of claim 40, wherein the M2-Peer module is further operable for identifying advertising information related to the media file in an M2-Peer communication header.

49. The wireless communication device of claim 41, wherein the media player application is operable for displaying advertising information included in the M2-Peer communication header.

50. A wireless communication device, the device comprising:
means for receiving two or more Multimedia Peer (M2-Peer) communications at a wireless communication device;
means for identifying the two or more M2-Peer communications as including an audio segment of a media file;
means for decoding the audio segments resulting in speech-grade audio segments of the media file; and
means for concatenating the audio segments of the media file to form an audio portion of the media file.
